(19) United States
(12) Patent Application Publication
(10) Pub. No.: US 2002/0114124 A1
(43) Pub. Date: Aug. 22, 2002

(54) Electrostatic clamping of gallium arsenide and other high resistivity materials

(75) Inventors: Kevin G. Rhoads, Andover, MA (US); Grant Kenji Larsen, Gloucester, MA (US)

Correspondence Address: Gary L. Loser, Esq., Varian Semiconductor Equipment Associates, Inc., 35 Dory Road, Gloucester, MA, 01930, US

(73) Assignee: Varian Semiconductor Equipment Associates, Inc.

(21) Appl. No.: 10/001,025

(22) Filed: Nov. 2, 2001

Related U.S. Application Data
(60) Provisional application No. 60/245,568, filed on Nov. 3, 2000.

(51) Int. Cl. H01H 1/00

(52) U.S. Cl. 361/234

(57) ABSTRACT

A method for electrostatic clamping of a high resistivity workpiece includes the steps of positioning a high resistivity workpiece on a clamping surface of an electrostatic clamp, the electrostatic clamp including electrodes underlying and electrically isolated from the clamping surface, and applying AC clamping voltages to the electrodes for electrostatically clamping the workpiece in a fixed position on the clamping surface. The AC clamping voltages have a frequency in a range of about 0.00175 Hz to 10 Hz and more preferably have a frequency in a range of about 1 Hz to 6 Hz.

### CROSS REFERENCE TO RELATED APPLICATION

This application claims the benefit of provisional application Serial No. 60/245,568 filed Nov. 3, 2000, which is hereby incorporated by reference.

### FIELD OF THE INVENTION

This invention relates to electrostatic clamping and, more particularly, to electrostatic clamping of gallium arsenide and other high resistivity materials. The invention is particularly useful in electrostatic wafer clamps for ion implantation systems, but is not limited to such use.

### BACKGROUND OF THE INVENTION

A known technique for clamping semiconductor wafers during processing involves the use of electrostatic forces. A dielectric layer is positioned between a semiconductor wafer and a conductive support plate. A voltage is applied between the semiconductor wafer and the support plate, and the wafer is clamped against the dielectric layer by electrostatic forces. Electrostatic wafer clamps are disclosed, for example, in U.S. Pat. No. 5,452,177 issued Sep. 19, 1995 to Frutiger; U.S. Pat. No. 5,969,934 issued Oct. 19, 1999 to Larsen; and U.S. Pat. No. 5,822,172 issued Oct. 13, 1998 to White.

Prior art electrostatic wafer clamps have proven to be very effective in clamping silicon semiconductor wafers during ion implantation. In some cases, however, electrostatic wafer clamps are required to clamp gallium arsenide wafers. Prior art electrostatic wafer clamps have not demonstrated satisfactory clamping performance in the case of gallium arsenide wafers. Accordingly, there is a need for improved methods and apparatus for electrostatic wafer clamping.

### SUMMARY OF THE INVENTION

According to an aspect of the invention, methods and apparatus for electrostatic clamping of a workpiece are provided. The apparatus comprises a platen assembly defining an electrically insulating clamping surface for receiving a workpiece, the platen assembly comprising electrodes underlying and electrically isolated from the clamping surface and a dielectric layer between the electrodes and the clamping surface, and a clamping control circuit for applying clamping voltages to the electrodes for electrostatically clamping the workpiece in a fixed position on the clamping surface.

The clamping control circuit applies to the electrodes AC clamping voltages that are preferably in a frequency range of about 0.00175 Hz-10 Hz and more preferably are in a frequency range of about 1 Hz-6 Hz. The preferred frequency range is effective in electrostatic clamping of gallium arsenide and other high resistivity materials including, but not limited to, non-predoped silicon, indium phosphide and gallium phosphide.

According to an aspect of the invention, a method is provided for electrostatic clamping of a high resistivity workpiece. The method comprises the steps of positioning the high resistivity workpiece on a clamping surface of an electrostatic clamp, the electrostatic clamp including electrodes underlying and electrically isolated from the clamping surface, and applying AC clamping voltages to the electrodes for electrostatically clamping the workpiece in a fixed position on the clamping surface. The AC clamping voltages have a frequency in a range of about 0.00175 Hz to 10 Hz, and more preferably have a frequency in a range of about 1 Hz to 6 Hz.

It is believed that the high resistivity of Gallium Arsenide limits the rate at which image charge can accumulate on the wafer backside and thereby limits the electrostatic force that can be achieved when higher frequency clamping voltages are used. This limitation can be overcome by operating the electrostatic wafer clamp in the frequency ranges specified above. At very low frequencies, flexurally induced declamping of the wafer may occur. Accordingly, the more preferred clamping voltage frequency of about 1 Hz to 6 Hz is a tradeoff between limiting flexurally induced declamping and overcoming the adverse effects of high resistivity. This approach may be utilized for electrostatic clamping of a variety of highly resistive materials.

### BRIEF DESCRIPTION OF THE DRAWINGS

For a better understanding of the present invention, reference is made to the accompanying drawings, which are incorporated herein by reference and in which:

FIG. 1 is a schematic plan view of an example of electrostatic wafer clamping apparatus suitable for implementing the present invention;

FIG. 2 is a schematic cross-sectional view of the wafer clamping apparatus, taken along the line 2-2 of FIG. 1; and

FIG. 3 is a schematic block diagram of the electrostatic wafer clamping apparatus, showing an example of a clamping control circuit.

### DETAILED DESCRIPTION

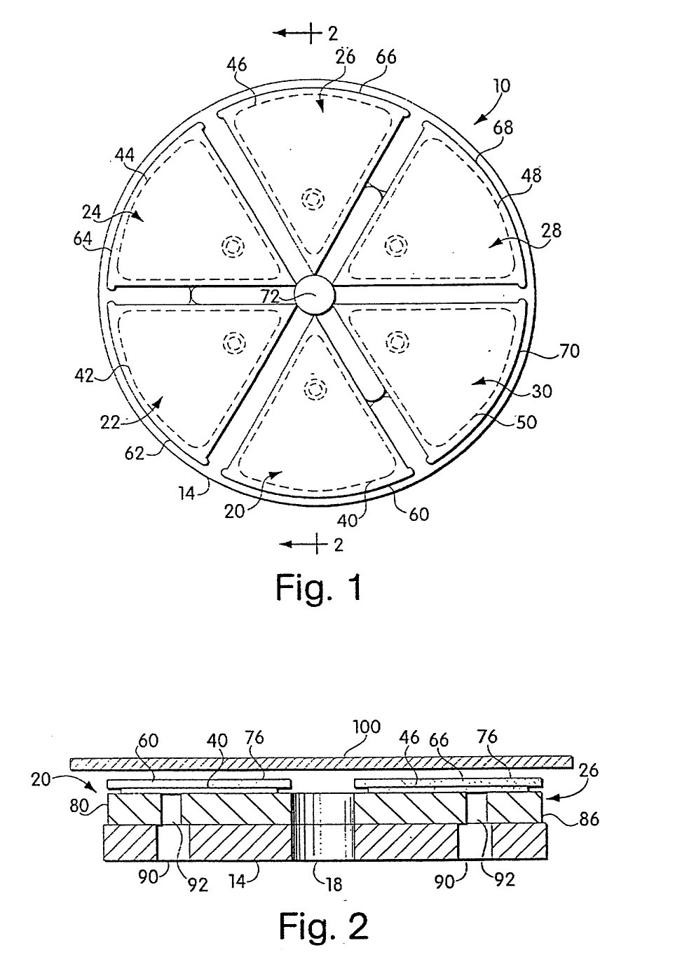

An example of apparatus for electrostatic clamping of a workpiece, such as a semiconductor wafer, is shown in simplified form in FIGS. 1-3. An electrostatic wafer clamping apparatus includes a platen 10 and a clamping control circuit 12 for applying clamping voltages to the platen 10 when clamping of a workpiece is desired. The platen 10 includes a support plate, or a platen base 14, and six sector assemblies 20, 22, 24, 26, 28 and 30 mounted on an upper surface of platen base 14. The platen base 14 is generally circular and may have a central opening 18 for a wafer lift mechanism (not shown).

Each of the sector assemblies includes a sector electrode located between an upper sector insulator and a lower sector insulator. Sector assemblies 20, 22, 24, 26, 28 and 30 include sector electrodes 40, 42, 44, 46, 48 and 50, respectively. Upper sector insulators 60, 62, 64, 66, 68 and 70 cover electrodes 40, 42, 44, 46, 48 and 50, respectively. The electrodes are preferably thin metal layers formed on the lower surfaces of the respective upper sector insulators. The electrodes 40, 42, 44, 46, 48 and 50 preferably have equal areas and are symmetrically disposed with respect to a center 72 of platen 10. The electrodes are electrically isolated from each other and, in a preferred embodiment, are sector-shaped as shown in FIG. 1. The upper surfaces of sector insulators 60, 62, 64, 66, 68 and 70 are coplanar. As discussed below, the upper section insulators preferably have a thin coating which defines a wafer clamping surface 76. When the coating is not utilized, the upper surfaces of the upper sector insulators define the wafer clamping surface. As shown in FIG. 2, sector assembly 20 includes a lower sector insulator 80 and sector assembly 26 includes a lower sector insulator 86. The remaining sector assemblies have the same construction. Preferably, the upper and lower sector insulators of each sector assembly overlap the edges of the respective electrodes to prevent contact between the electrodes and the wafer.

In the embodiment of FIGS. 1-3, a separate sector assembly including sector-shaped upper and lower sector insulators, is fabricated for each electrode. In other embodiments, the upper insulator or the lower insulator, or both, may be formed as a circular disk. Multiple electrodes may be formed on the lower surface of the circular upper insulator. This configuration may be practical for relatively small platens.

The platen base 14 and the lower sector insulators 80, 86, etc., are provided with aligned openings 90 and 92, respectively, underlying each of the electrodes. The openings 90 and 92 permit electrical connection to each of the electrodes. A semiconductor wafer 100 is shown in FIG. 2 positioned above clamping surface 76. When clamping voltages are applied to electrodes 40, 42, 44, 46, 48 and 50, the wafer 100 is electrostatically clamped in a fixed position against clamping surface 76.

The upper sector insulators 60, 62, 64, 66, 68 and 70 are preferably a hard ceramic material that has high dielectric strength and high permitivity, and does not exhibit bulk polarization at the frequency and voltage used for clamping. Preferred materials include alumina, sapphire, silicon carbide and aluminum nitride. The upper sector insulators may, for example, have a thickness of about 0.008 inch to permit reliable clamping with a voltage having a peak amplitude of about 1,000 volts. The upper surfaces of the upper sector insulators are ground flat to within 0.001 inch.

The electrodes 40, 42, 44, 46, 48 and 50 are preferably formed by depositing metal layers on the lower surfaces of the respective upper sector insulators 60, 62, 64, 66, 68 and 70. In a preferred embodiment, the electrodes comprise a conductive coating of niobium. The thickness of each electrode is typically on the order of about one micrometer. Other suitable conductive metal layers may be used within the scope of the invention. For example, titanium-molybdenum electrodes are described in the aforementioned U.S. Pat. No. 5,452,177.

The lower sector insulators have sufficient thickness to provide structural rigidity and to electrically isolate the electrodes. The lower sector insulators are preferably fabricated of the same or a similar material as the upper sector insulators for matching of thermal expansion coefficients. In a preferred embodiment, the lower sector insulators are fabricated of alumina. The platen base 14 is typically fabricated of a metal such as aluminum.

The clamping voltages applied to the electrodes of platen 10 are preferably bipolar square waves having six different phases (0°, 60°, 120°, 180°, 240° and 300°). The phases of the voltages applied to electrodes on opposite sides of platen 10 are one-half cycle, or 180°, out of phase. Thus, the voltages applied to electrodes 40 and 46 are one-half cycle out of phase; the voltages applied to electrodes 42 and 48 are one-half cycle out of phase; and the voltages applied to electrodes 44 and 50 are one-half cycle out of phase. The disclosed clamping apparatus provides reliable clamping and unclamping of wafers without requiring electrical contact to the wafer and without producing charging currents which could potentially damage the wafer.

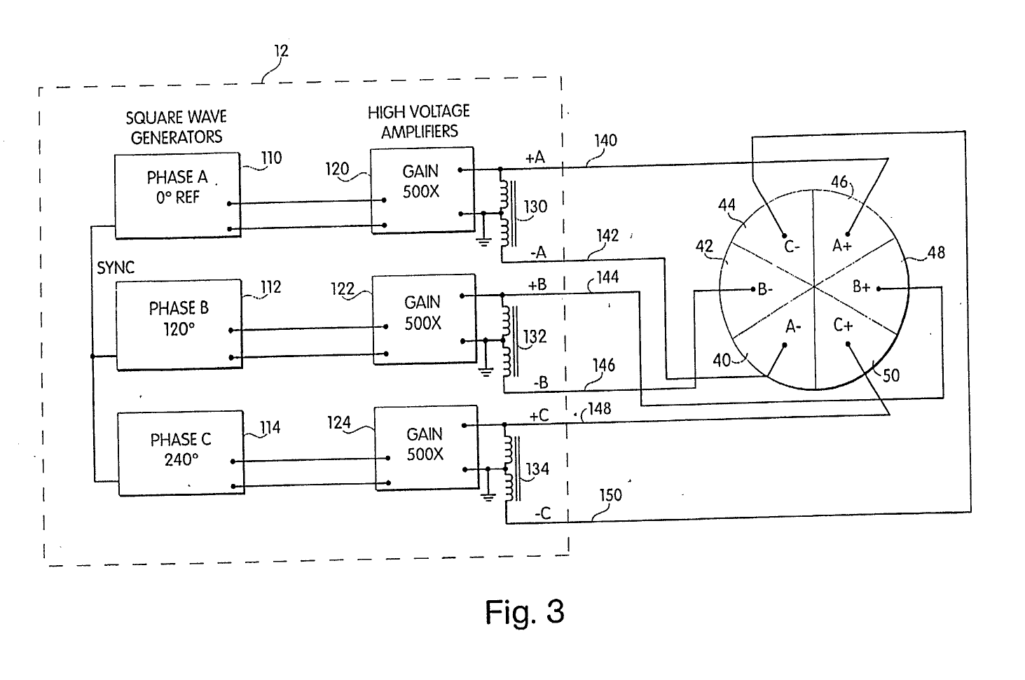

An example of a suitable clamping control circuit 12 is shown in FIG. 3. Square wave generators 110, 112 and 114 supply low voltage square waves to amplifiers 120, 122 and 124, respectively. The outputs of amplifiers 120, 122 and 124 are applied to high voltage inverter transformers 130, 132 and 134, respectively. The transformers 130, 132 and 134 produce output voltages that are 180°, or one-half cycle, out of phase. The outputs of transformer 130 on lines 140 and 142 are bipolar square waves that are one-half cycle out of phase. The outputs on lines 140 and 142 are connected to electrodes 46 and 40, respectively. The outputs of transformer 130 on lines 144 and 146 are bipolar square waves that are one-half cycle out of phase and are shifted by 120° relative to the outputs of transformer 130. The outputs of transformer 132 on lines 144 and 146 are connected to electrodes 48 and 42, respectively. The outputs of transformer 134 on lines 148 and 150 are one-half cycle out of phase and are shifted by 240° relative to the outputs of transformer 130. The outputs of transformer 134 on lines 148 and 150 are connected to electrodes 50 and 44, respectively. This configuration provides six phase clamping of the wafer. Additional details regarding the clamping control circuit and the clamping voltages are provided in the aforementioned U.S. Pat. No. 4,452,177, which is hereby incorporated by reference.

The electrostatic wafer clamping apparatus shown in FIGS. 1-3 and described above works well for clamping of silicon semiconductor wafers using 30 Hz square wave clamping voltages. However, this implementation does not demonstrate satisfactory performance in clamping gallium arsenide wafers.

In wafers of high resistivity materials, the rate of charge transport becomes a limiting factor in the generation of image charge. When a wafer is subjected to externally imposed electric fields, it responds by accumulating image charge on the surface to shield out the fields. This is a common behavior of all conductive materials. If the conductivity is high, this process occurs rapidly, and shielding is close to perfect throughout the range of frequencies of interest. This is true of silicon wafers, where shielding is perfect to frequencies much higher than those used in conventional electrostatic clamps, and surface image charges develop “instantly” in comparison with the period of the applied frequency. An alternative characterization is that the hierarchy of time constants is arranged so that the time constant of image charge accumulation is so much shorter than other time constants, such as the slew rate of the power supply, that it can be treated as instantaneous. In other words, for silicon the power supply limits the rate of image charge accumulation.

In gallium arsenide and other compound semiconductors, however, the intrinsic resistivity is typically high enough to limit the rate at which the process of image charge accumulation proceeds. As a result, surface image charges are not fully developed during the time in which one polarity of the AC clamping voltage is applied at the frequencies normally used for electrostatic clamps. Before the image charge can fully develop, the AC clamping voltage reverses polarity and begins driving the charge in the opposite direction. In the time constant characterization, the image charge accumulation time constant is much slower than in the case of silicon and is the rate limiting process.

Slow image charge accumulation has two implications. First, since the image charge does not fully develop, the force, which is charge times field, is lower. Second, since the field reverses rapidly when the voltage is switched, there is a time when the charge of the last half cycle remains, now generating a repulsive force instead of an attractive force, until such time as that charge can dissipate and charge of the opposite sign begins to accumulate. Together, these effects cause a reduction in net, i.e., time averaged, attractive force with increasing frequency.

According to an aspect of the invention, the frequency used for electrostatic clamping of high resistivity wafers and other high resistivity workpieces is sufficiently low to provide time for the image charge to accumulate. Based on limited testing with gallium arsenide wafers, full charge will develop when the frequency is under a few millihertz.

The above-described charging time constant results in limitations of force generation at higher frequencies for resistive wafer materials. This dependence has been confirmed by direct force measurement with gallium arsenide wafers. In addition, other limitations of force generation were observed, which are attributed to wafer flexural response to applied force. As the operating frequency is lowered, the transition times, when the voltage applied to a pair of electrodes is being slewed from positive to negative or the reverse, take longer. Apparently, the flexural response of the wafer has one or more time constants which affect clamping performance at lower frequencies. In particular, portions of the wafer clamped by electrodes having applied voltages which are slewing through zero volts can relax away from the electrodes. This effect imposes a lower limit on the operating frequency of the electrostatic clamp.

Accordingly, the clamping control circuit applies to the electrodes of the electrostatic clamp AC clamping voltages that are preferably in a frequency range of about 0.00175 Hz to 10 Hz and more preferably are in a frequency range of about 1 Hz to 6 Hz. The preferred frequency range is effective in electrostatic clamping of gallium arsenide and other high resistivity materials including, but not limited to, non-predoped silicon, indium phosphide and gallium phosphide.

While there have been shown and described what are at present considered the preferred embodiments of the present invention, it will be obvious to those skilled in the art that various changes and modifications may be made therein without departing from the scope of the invention as defined by the appended claims.

1. A method for electrostatic clamping of a high resistivity workpiece, comprising the steps of:
positioning a high resistivity workpiece on a clamping surface of an electrostatic clamp, said electrostatic clamp including electrodes underlying and electrically isolated from said clamping surface; and
applying AC clamping voltages to said electrodes for electrostatically clamping the workpiece in a fixed position on said clamping surface, said AC clamping voltages having a frequency in a range of about 0.00175 Hz to 10 Hz.

2. A method as defined in claim 1 wherein the step of positioning a high resistivity workpiece comprises positioning a gallium arsenide wafer.

3. A method as defined in claim 1 wherein said AC clamping voltages have a frequency in a range of about 1 Hz to 6 Hz.

4. A method as defined in claim 1 wherein the step of positioning a high resistivity workpiece comprises positioning a gallium phosphide, indium phosphide or non-predoped silicon workpiece.
